(19) United States
(12) Patent Application Publication
(10) Pub. No.: US 2018/0015316 A1
(43) Pub. Date: Jan. 18, 2018

(54) Automated Spray Assembly

(71) Applicants: Sherman Mitchell, Portland, OR (US); Zachariah I. Kelly, Portland, OR (US)

(72) Inventors: Sherman Mitchell, Portland, OR (US); Zachariah I. Kelly, Portland, OR (US)

(21) Appl. No.: 15/212,558

(22) Filed: Jul. 18, 2016

(51) Int. Cl. A62C 37/08; A62C 3/02

(52) U.S. Cl. CPC A62C 37/08; A62C 3/0292

(57) ABSTRACT

An automated spray assembly for fire suppression includes a controller, a power module, a pump, a tank, a plurality of emitters and a plurality of sensors. The power module, the pump, the emitters and the sensors are operationally coupled to the controller. The tank, which is configured to store a fire suppressing liquid, and the emitters are fluidically coupled to the pump. The emitters are configured to spray the fire suppressing liquid on an exterior of a structure. The sensors are positioned proximate to the structure. The sensors are configured to detect a fire proximate to the structure and to signal the controller to motivate the pump to compel the fire suppressing liquid through the emitters to the exterior of the structure.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to spray assemblies and more particularly pertains to a new spray assembly for fire suppression.

### BRIEF SUMMARY OF THE INVENTION

An embodiment of the disclosure meets the needs presented above by generally comprising a controller, a power module, a pump, a tank, a plurality of emitters and a plurality of sensors. The power module, the pump, the emitters and the sensors are operationally coupled to the controller. The tank, which is configured to store a fire suppressing liquid, and the emitters are fluidically coupled to the pump. The emitters are configured to spray the fire suppressing liquid on an exterior of a structure. The sensors are positioned proximate to the structure. The sensors are configured to detect a fire proximate to the structure and to signal the controller to motivate the pump to compel the fire suppressing liquid through the emitters to the exterior of the structure.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an automated spray assembly according to an embodiment of the disclosure.

FIG. 2 is a side view of an embodiment of the disclosure.

FIG. 3 is a top view of an embodiment of the disclosure.

FIG. 4 is a detail view of an embodiment of the disclosure.

FIG. 5 is a block diagram of an embodiment of the disclosure.

FIG. 6 is an isometric perspective view of an embodiment of the disclosure.

### DETAILED DESCRIPTION OF THE INVENTION

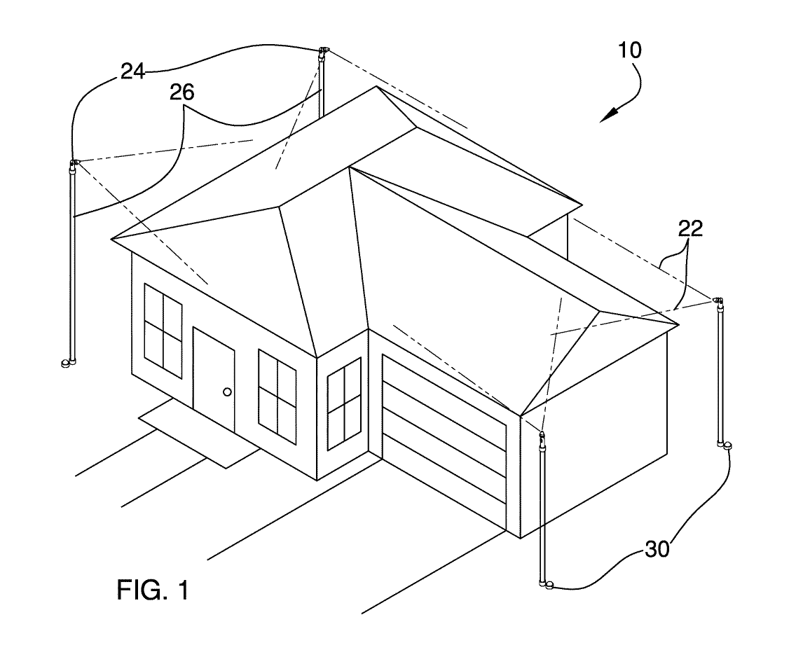

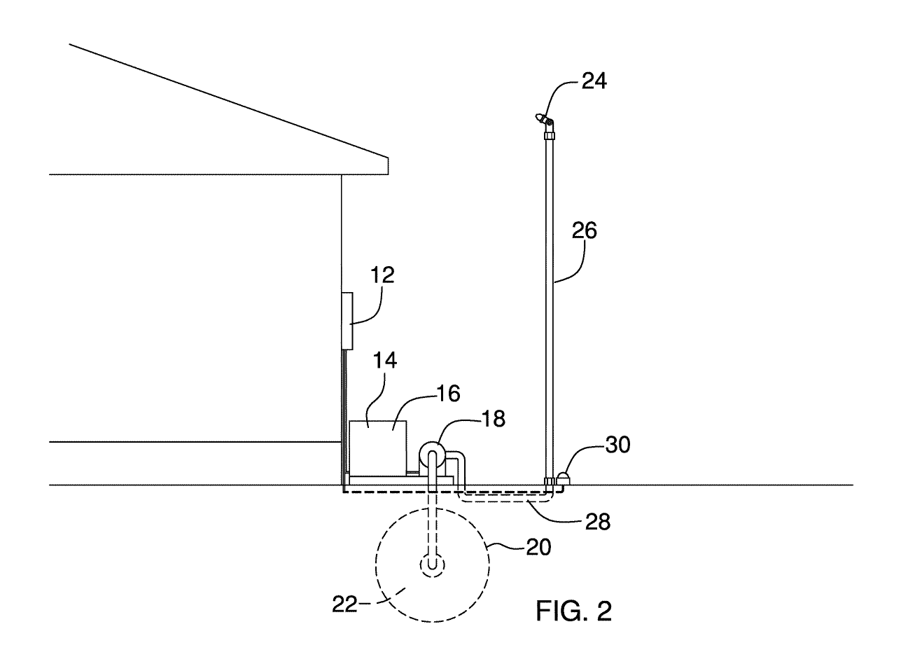

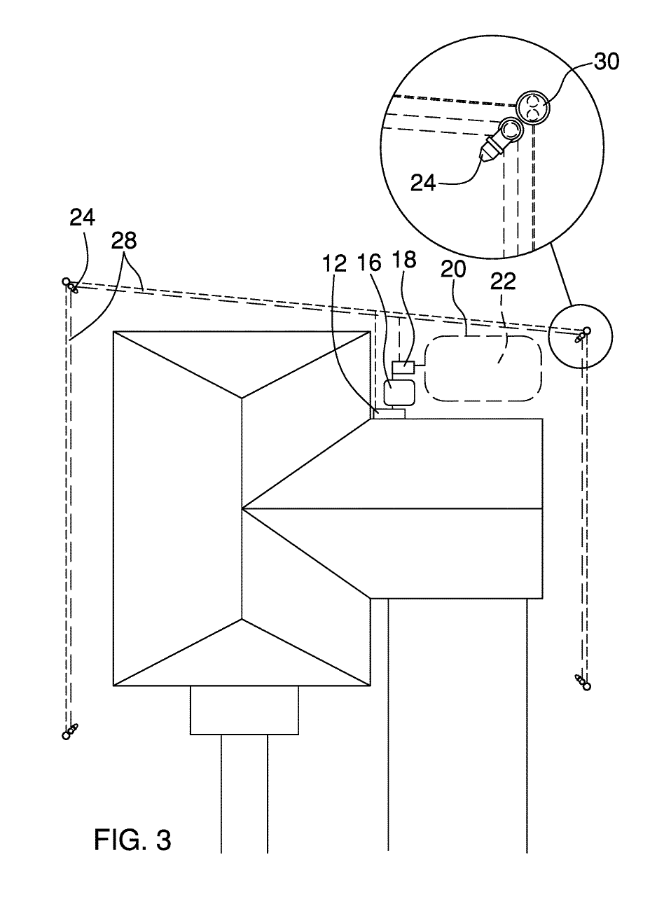

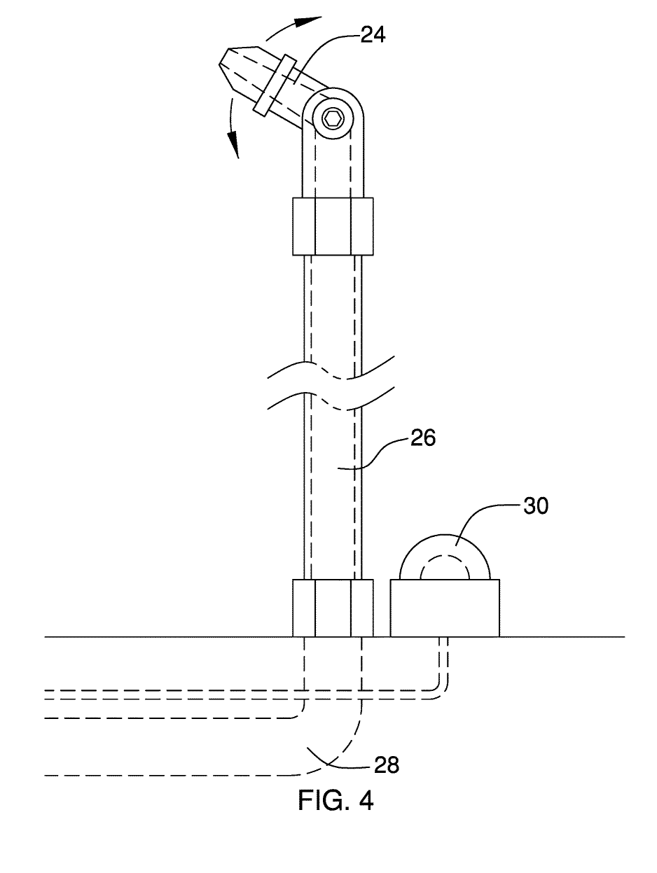

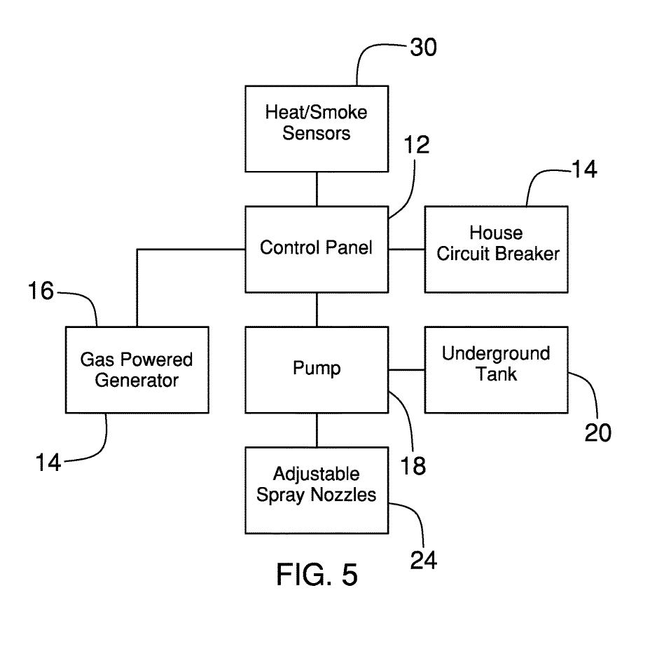

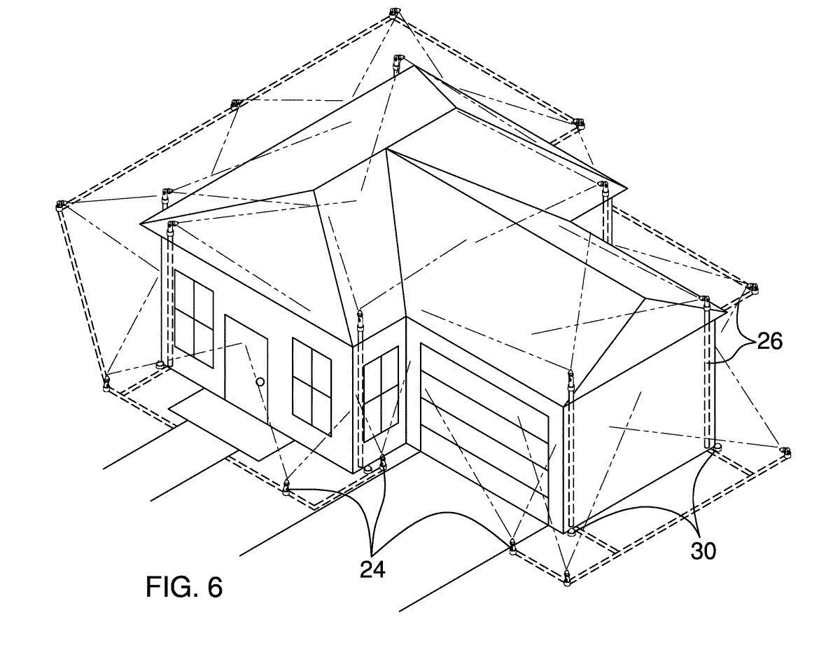

With reference now to the drawings, and in particular to FIGS. 1 through 6 thereof, a new spray assembly embodying the principles and concepts of an embodiment of the disclosure and generally designated by the reference numeral 10 will be described.

As best illustrated in FIGS. 1 through 6, the automated spray assembly 10 generally comprises a controller 12 that is configured to couple to a structure. A power module 14 is operationally coupled to the controller 12. In one embodiment, the power module 14 comprises an electrical circuit of the structure. In another embodiment, the power module 14 comprises a generator 16. In yet another embodiment, the generator 16 is gas powered.

A pump 18 is operationally coupled to the controller 12. A tank 20 is fluidically coupled to the pump 18. The tank 20 is configured to store a fire suppressing liquid 22. In one embodiment, the tank 20 is configured to position beneath ground.

A plurality of emitters 24 is fluidically coupled to the pump 18. The emitters 24 are configured to spray the fire suppressing liquid 22 on an exterior of the structure. The emitters 24 are adjustably positionable such that spray emanating from the emitters 24 is selectively directable to the exterior of the structure and to surfaces adjacent to the structure.

In one embodiment, the assembly 10 comprises a plurality of pipes 26. Each pipe 26 is selectively couplable to a respective emitter 24. The pipe 26 is couplable to the respective emitter 24 such that the respective emitter 24 is selectively vertically positionable. In another embodiment, the pipes 26 are positioned proximate to the structure. In yet another embodiment, the pipes 26 are integral to the structure.

In one embodiment, the assembly 10 comprises a plurality of tubes 28. Each tube 28 is fluidically coupled to the pump 18 and a respective emitter 24. In another embodiment, the tubes 28 comprise polyvinyl chloride.

A plurality of sensors 30 is positioned proximate to the structure and operationally coupled to the controller 12. The sensors 30 are configured to detect a fire proximate to the structure. In one embodiment, the sensors 30 are configured to detect heat. In another embodiment, the sensors 30 are configured to detect smoke. In yet another embodiment, the sensors 30 are configured to detect heat and smoke. In still yet another embodiment, the each sensor 30 is positioned proximate to an associated pipe 26.

The present invention also anticipates a reservoir that is fluidically coupled to the pump 18 and operationally coupled to the controller 12. The reservoir would be utilized to store a wetting agent that would be metered into the fire suppressing liquid 22 as it passes through the pump 18.

In use, the sensors 30 are configured to detect a fire proximate to the structure and to signal the controller 12 to motivate the pump 18 to compel the fire suppressing liquid 22 through the emitters 24 to the exterior of the structure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automated spray assembly comprising:
a controller;
a power module operationally coupled to said controller;
a pump operationally coupled to said controller;
a tank fluidically coupled to said pump, said tank being configured for storage of a fire suppressing liquid;
a plurality of emitters fluidically coupled to said pump, said emitters being configured to spray said fire suppressing liquid on an exterior of a structure;
a plurality of sensors positioned proximate to the structure and operationally coupled to said controller, said sensors being configured to detect a fire proximate to the structure; and
wherein said sensors are configured to detect a fire proximate to the structure and to signal said controller to motivate said pump to compel said fire suppressing liquid through said emitters to the exterior of the structure.

2. The assembly of claim 1, further including said controller being configured for coupling to the structure.

3. The assembly of claim 1, further including said power module comprising an electrical circuit of the structure.

4. The assembly of claim 1, further including said power module comprising a generator.

5. The assembly of claim 4, further including said generator being gas powered.

6. The assembly of claim 1, further including said tank being configured for positioning beneath ground.

7. The assembly of claim 1, further including said emitters being adjustably positionable such that spray emanating from said emitters is selectively directable to the exterior of the structure and to surfaces adjacent to the structure.

8. The assembly of claim 1, further including a plurality of pipes, each said pipe being selectively couplable to a respective said emitter, wherein said pipe is couplable to said respective said emitter such that said respective said emitter is selectively vertically positionable.

9. The assembly of claim 8, further including said pipes being positioned proximate to the structure.

10. The assembly of claim 8, further including said pipes being integral to the structure.

11. The assembly of claim 1, further including a plurality of tubes, each said tube being fluidically coupled to said pump and a respective said emitter.

12. The assembly of claim 11, further including said tubes comprising polyvinyl chloride.

13. The assembly of claim 1, further including said sensors being configured to detect heat.

14. The assembly of claim 1, further including said sensors being configured to detect smoke.

15. The assembly of claim 14, further including said sensors being configured to detect heat.

16. The assembly of claim 8, further including each said sensor being positioned proximate to an associated said pipe.

17. An automated spray assembly comprising:
a controller, said controller being configured for coupling to a structure;
a power module operationally coupled to said controller, said power module comprising an electrical circuit of the structure, said power module comprising a generator, said generator being gas powered;
a pump operationally coupled to said controller;
a tank fluidically coupled to said pump, said tank being configured for storage of a fire suppressing liquid, said tank being configured for positioning beneath ground;
a plurality of emitters fluidically coupled to said pump, said emitters being configured to spray said fire suppressing liquid on an exterior of a structure, said emitters being adjustably positionable such that spray emanating from said emitters is selectively directable to the exterior of the structure and to surfaces adjacent to the structure;
a plurality of pipes, each said pipe being selectively couplable to a respective said emitter, wherein said pipe is couplable to said respective said emitter such that said respective said emitter is selectively vertically positionable, said pipes being positioned proximate to the structure, said pipes being integral to the structure;
a plurality of tubes, each said tube being fluidically coupled to said pump and a respective said emitter, said tubes comprising polyvinyl chloride;
a plurality of sensors positioned proximate to the structure and operationally coupled to said controller, said sensors being configured to detect a fire proximate to the structure, said sensors being configured to detect heat, said sensors being configured to detect smoke, said sensors being configured to detect heat and smoke, each said sensor being positioned proximate to an associated said pipe; and
wherein said sensors are configured to detect a fire proximate to the structure and to signal said controller to motivate said pump to compel said fire suppressing liquid through said emitters to the exterior of the structure.
